(19) United States
(12) Patent Application Publication
(10) Pub. No.: US 2011/0062702 A1
(43) Pub. Date: Mar. 17, 2011

(54) HOSE MANIFOLD WITH INTEGRATED FILTRATION AND SHUT-OFF CHECK VALVES

(76) Inventors: Christopher J. Pellin, Burnsville, MN (US); Joseph E. Tix, Hastings, MN (US); Mark T. Weinberger, Mounds View, MN (US)

(21) Appl. No.: 12/992,821

(22) PCT Filed: May 14, 2009
(86) PCT No.: PCT/US09/43890

§ 371 Date: Nov. 15, 2010

Related U.S. Application Data
(60) Provisional application No. 61/053,786, filed on May 16, 2008.

(51) Int. Cl. F16L 41/00

(52) U.S. Cl. 285/125.1

(57) ABSTRACT

The hose manifold integrates fluid filtration using cylindrical mesh screens and incorporates a check valve backup fluid shut-off system into the hose manifold. Two threaded check valve assemblies (one assembly on the iso side, one on the resin side) with slip on cylindrical filter screens are assembled into the hose manifold to filter the iso and resin fluids. When the hose manifold is assembled to the main fluid section of the foam applicator, pin features within the main fluid section open the spring loaded check balls in the hose manifold to allow for full fluid flow to the main fluid section.

### TECHNICAL FIELD

This application claims the benefit of US Application Ser. No. 61/053,786, filed May 16, 2008, the contents of which are hereby incorporated by reference.

### BACKGROUND ART

Spray guns for application of fast setting materials such as polyurethanes and polyureas are well known. Because these materials set up so fast, it is important that the gun or applicator be easily disassembled with a minimum of tools for cleaning.

### DISCLOSURE OF THE INVENTION

The instant invention integrates fluid filtration by means of cylindrical mesh screens and incorporates a check valve backup fluid shut-off system into the hose manifold. Two threaded check valve assemblies (one assembly on the iso side, one on the resin side) with slip on cylindrical filter screens are assembled into the hose manifold to filter the iso and resin fluids.

When the hose manifold is assembled to the main fluid section of the foam applicator, pin features within the main fluid section open the spring loaded check balls in the hose manifold to allow for full fluid flow to the main fluid section. When the hose manifold is removed from the main fluid section, the spring-loaded balls automatically check to act as a backup shut-off system and prevent fluid leakage. The hose manifold does not need to be removed from main fluid section to access the filter screens.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 shows a cross-section of the manifold of the instant invention.

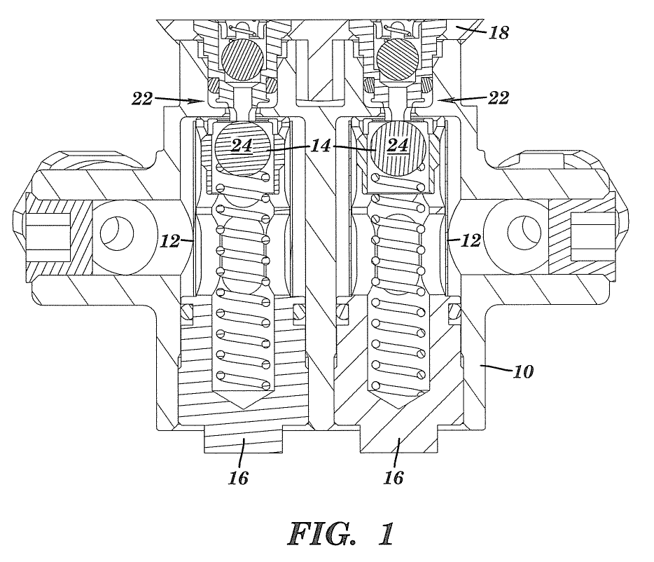

FIG. 2 is an exploded view of a spray gun with the hose manifold.

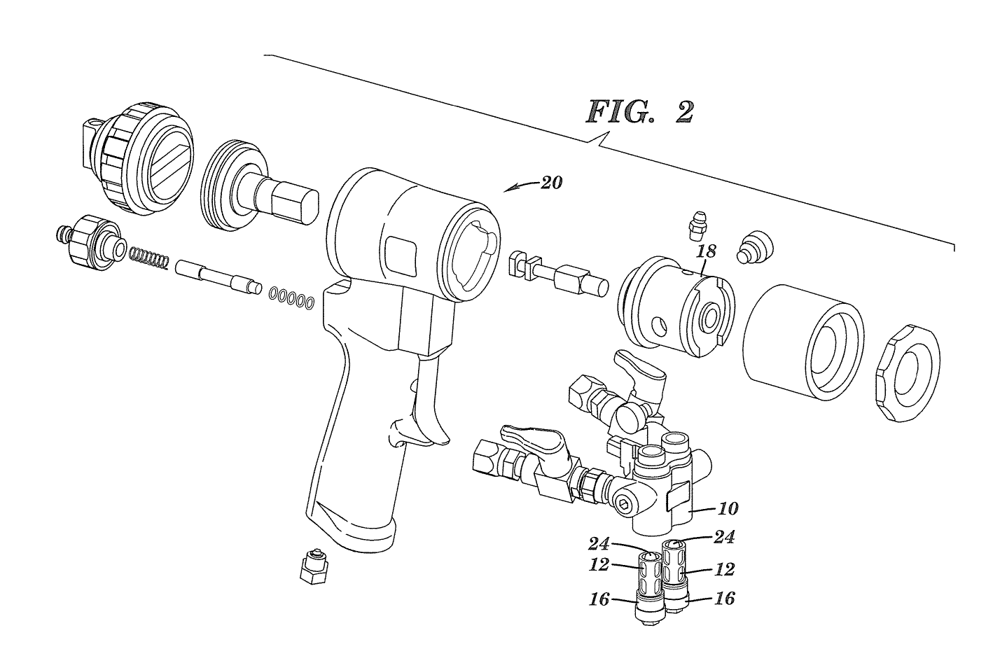

### BEST MODE FOR CARRYING OUT THE INVENTION

The hose manifold 10 of the instant invention integrates fluid filtration by means of cylindrical mesh screens 12 and incorporates a check valve 14 backup fluid shut-off system into the hose manifold 10. Two threaded check valve assemblies 16 (one assembly on the iso side, one on the resin side) with slip on cylindrical filter screens 12 are assembled into the hose manifold 10 to filter the iso and resin fluids.

When the hose manifold 10 is assembled to the main fluid section 18 of the foam applicator 20, pin features 22 within the main fluid section 18 open the spring loaded check balls 24 in the hose manifold 10 to allow for full fluid flow to the main fluid section 18. When the hose manifold 10 is removed from the main fluid section 18, the spring-loaded balls 24 automatically check to act as a backup shut-off system and prevent fluid leakage. The hose manifold 10 does not need to be removed from main fluid section 18 to access the filter screens 12 which may be removed or cleaned by unscrewing check assemblies 16 from the bottom of hose manifold 10.

It is contemplated that various changes and modifications may be made to the hose manifold without departing from the spirit and scope of the invention as defined by the following claims.

1. A hose manifold assembly for a fast set plural component spray gun having a housing, said assembly comprising:
a main fluid section;
at least two check valve assemblies, each said check valve assembly comprising a spring-loaded check ball and a cylindrical mesh screen; and
said main fluid section having a pin within said main fluid section open said spring-loaded check balls when said hose manifold is assembled to said main fluid section and whereby when said hose manifold is removed from said main fluid section, said spring-loaded balls automatically check to act as a backup shut-off system and prevent fluid leakage.
